(19) United States
(12) Patent Application Publication
(10) Pub. No.: US 2013/0228149 A1
(43) Pub. Date: Sep. 5, 2013

(54) Rotary Internal Combustion Engine

(71) Applicant: Heping Ma, Fontana, CA (US)

(72) Inventor: Heping Ma, Fontana, CA (US)

(21) Appl. No.: 13/410,117

(22) Filed: Mar. 1, 2012

(51) Int. Cl. F02B 53/04

(52) U.S. Cl. 123/200

(57) ABSTRACT

The present invention is a rotary internal combustion engine, comprising an outer stator shell which forms several equal-sized stator chambers and an oscillating axle which forms several pistons corresponding to the stator chambers and separating each stator chamber into two sealed combustion chambers. When operating, the combustions of the combustion chambers cause the oscillating axle to oscillate. The oscillating motion is then translated to a mono-directional rotary motion, which provides the power output.

### FIELD OF THE INVENTION

The present invention relates to internal combustion engines.

### BACKGROUND OF THE INVENTION

The traditional cylindrical design of internal combustion engine has many shortcomings. One of the most notable is the wear and tear of the piston and the rings that seal the cylinders.

There are many such designs of rotary internal combustion engines. U.S. Pat. Nos. 3,745,979, 4,036,183, 4,178,902, 5,555,866, 6,543,406, 6,539,913, 6,662,774, and 7,621,167, U.S. Pat. App. Nos. 2010/0000492 and 2011/0048370.

### SUMMARY OF THE INVENTION

The present invention provides a rotary internal combustion engine construction which uses a rotary design to solve problems of the cylindrical design, e.g., the wear and tear of the piston and the sealing ring to seal the combustion chamber, while not losing the simplicity of the cylindrical design.

In one embodiment of the present invention, inward protruding walls of an outer stator shell separate the inner space into four stator chambers. Stator sealing members are installed at inner ends of the inward protruding walls to seal the space between the outer stator shell and an oscillating axle. At both ends of each stator chamber, a spark plug, an inlet valve, and an exhaust valve are installed. Four pistons, which are part of the oscillating axle, comprise piston sealing members at the outer tip of the pistons to seal the space between the piston and the outer stator shell.

The pistons separate four stator chambers into eight combustion chambers. When the combustion chambers operate in two-stroke cycles, the combustion in one combustion chamber will push the oscillating axle to move in one direction and the combustion in the other combustion chamber in the same stator chamber will push the piston back to the original position.

The preferred embodiment employs crankshafts to translate the oscillating motion of the oscillating axle into mono-directional rotary motion of a power output axle.

### BRIEF DESCRIPTION OF THE DRAWINGS

FIG. 1 is a cross-sectional view showing the combustion chambers of the present invention taken along the line A-A of FIG. 12;

FIGS. 2-5 are drawings showing different phases of the operation of the combustion chambers of the present invention in two-stroke cycle design;

FIGS. 6-9 are drawings showing different phases of the operation of the combustion chambers of the present invention in four-stroke cycle design;

FIG. 10 is a cross-sectional view showing the crankshaft of the present invention taken along the line C-C of FIG. 12;

FIG. 11 is a cross-sectional perspective view of the combustion chambers of the present invention;

FIG. 12 is a cross-sectional view showing the combustion chambers and the crankshaft of the present invention taken along the line B-B of FIG. 1; and

FIG. 13 is an exploded perspective view of the present invention.

### DETAILED DESCRIPTION OF THE INVENTION

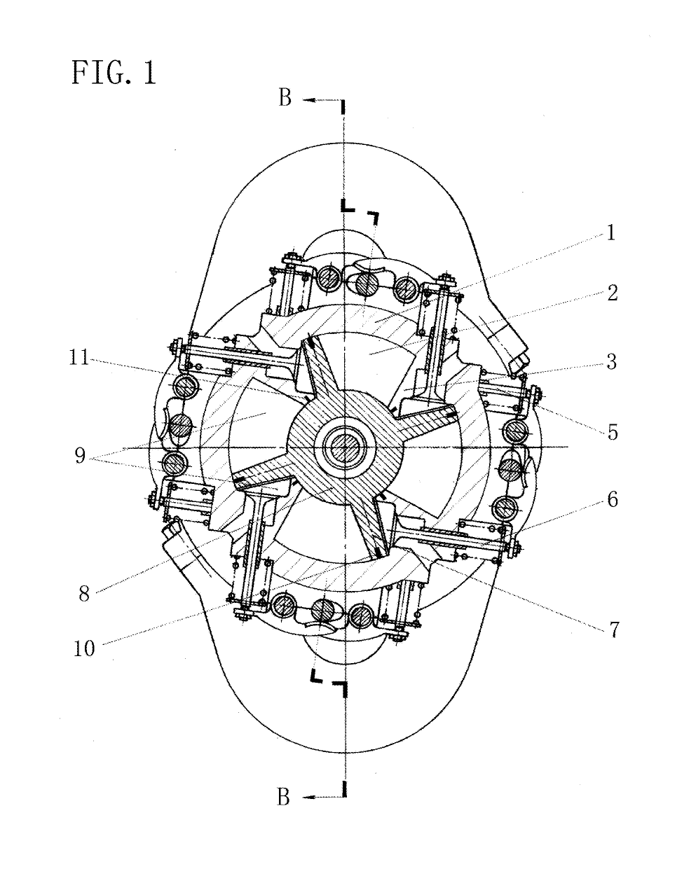

FIG. 1 shows one of the preferred embodiments of the present invention. An outer stator shell 1 forms four stator chambers 2 with four outer stator shell walls 3. At each end of each stator chamber, a spark plug 4, an inlet valve 5, and an exhaust valve 6 are installed.

Four pistons 7, which form the part of an oscillating axle 8, separates each stator chamber 2 into two combustion chambers 9. A piston sealing member 10 is attached at the outer edge of the pistons 7 to seal the space between the piston 7 and inner wall of the stator chamber 2. Stator sealing members 11 are installed at the inner edge of the outer stator shell walls 3 to seal the space between the outer stator shell walls 3 and oscillating axle 8.

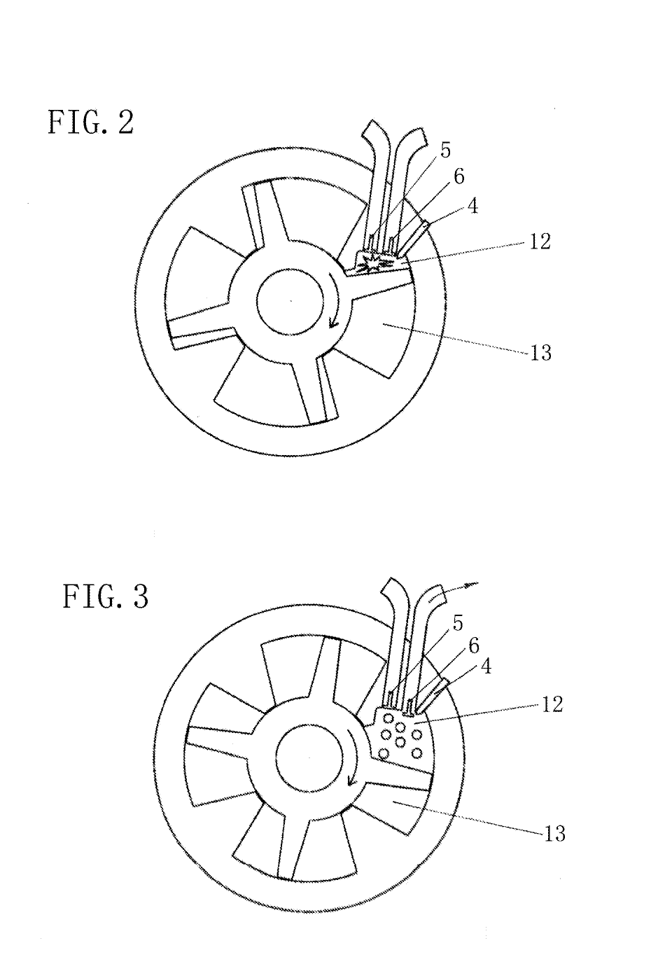

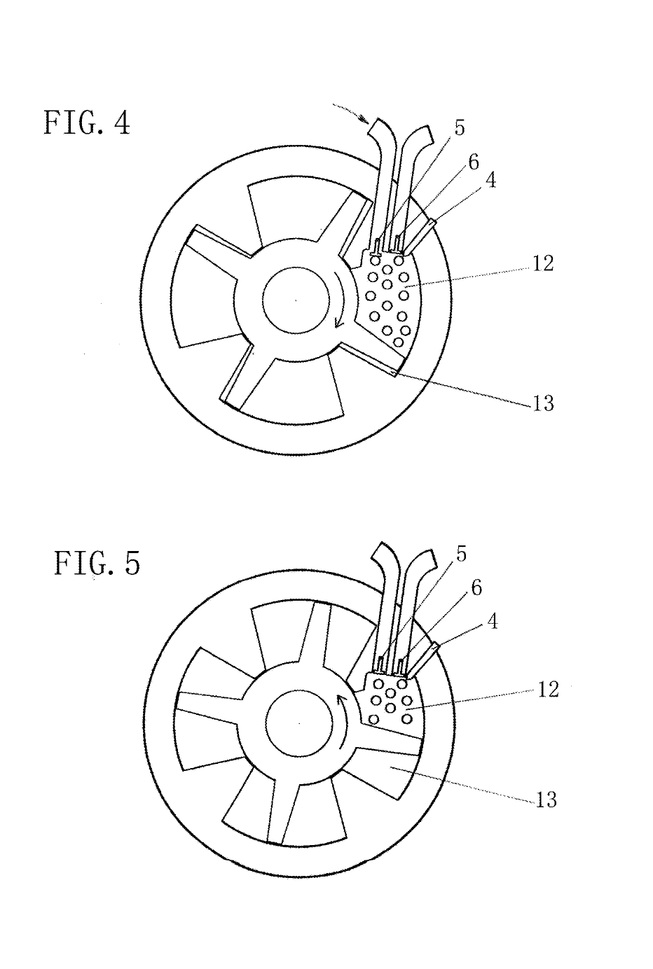

FIGS. 2-5 show the operation in one of the stator chambers 2 in the two-stroke cycle design. FIG. 2 shows the combustion of the Combustion Chamber 12 at the initial stage of the combustion stroke, compressing the Combustion Chamber 13; FIG. 3 shows the exhaust exits the Combustion Chamber 12 through the exhaust valve 6, while the Combustion Chamber 13 is further compressed. FIG. 4 shows the compressed air, mixed with fuel, entering the Combustion Chamber 12 through the inlet valve 5, while the Combustion Chamber 13 is further compressed. FIG. 5 shows the compression stroke when the combustion of the Combustion Chamber 13 helps compressing the Combustion Chamber 12.

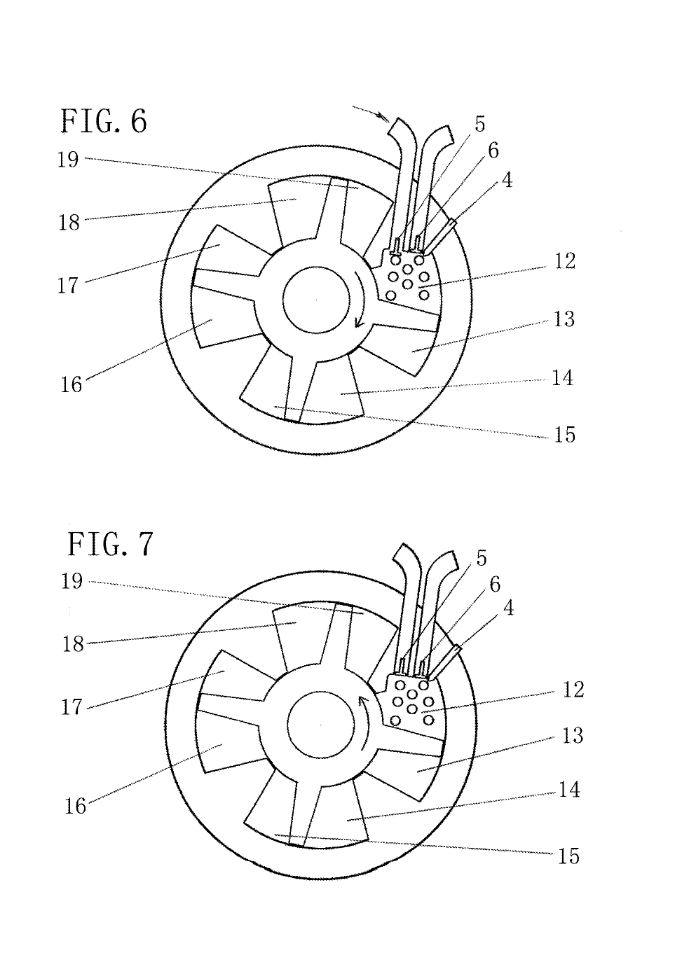

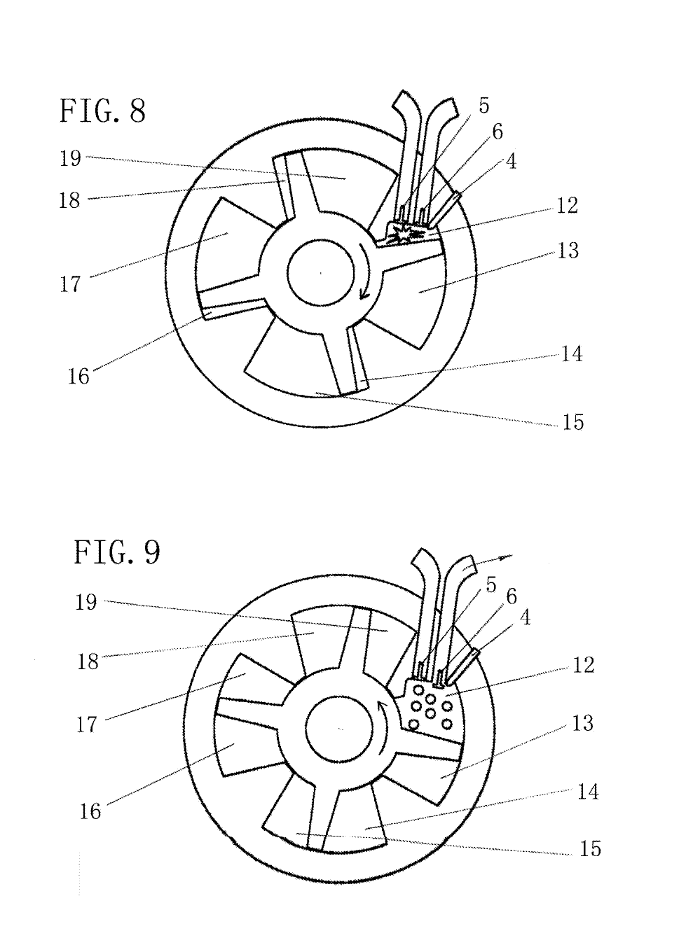

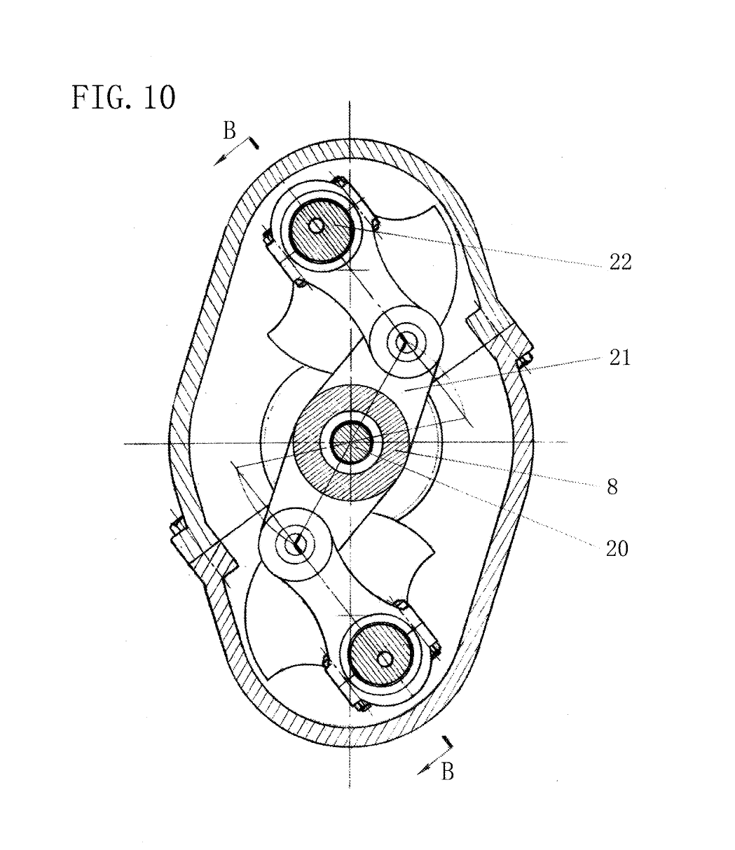

FIGS. 6-9 show the operation in one stator chamber 2 in the four-stroke cycle design. FIG. 6 shows the Combustion Chambers 12 and 16 at induction cycle. Combustion Chambers 13 and 17 are at compression cycle at this time. Combustion Chambers 14 and 18 are at ignition cycle. Combustion Chambers 15 and 19 are at emission cycle. FIG. 7 shows the Combustion Chambers 12 and 16 at compression cycle. Combustion Chambers 13 and 17 are at ignition cycle at this time. Combustion Chambers 14 and 18 are at emission cycle. Combustion Chambers 15 and 19 are at induction cycle. FIG. 8 shows the Combustion Chambers 12 and 16 at ignition cycle. Combustion Chambers 13 and 17 are at emission cycle at this time. Combustion Chambers 14 and 18 are at induction cycle. Combustion Chambers 15 and 19 are at compression cycle. FIG. 9 shows the Combustion Chambers 12 and 16 at emission cycle. Combustion Chambers 13 and 17 are at induction cycle at this time. Combustion Chambers 14 and 18 are at compression cycle. Combustion Chambers 15 and 19 are at ignition cycle.

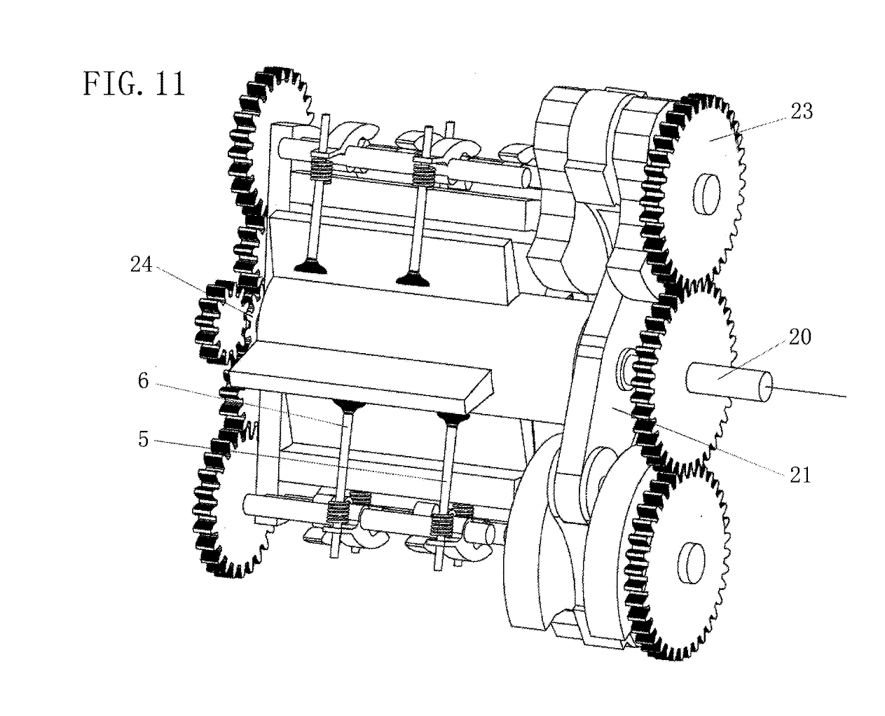

FIG. 10 shows the crankshaft mechanism that translates the oscillating motion of the oscillating axle 8 into mono-directional rotary motion and to a power output axle 20. As oscillating axle 8 oscillates, oscillating axle arm 21 oscillates with it. In this embodiment, Crankshaft 22 translates the oscillation into mono-directional rotary motion of the crankshaft gears 23 (FIG. 11).

FIG. 11 shows the control gears 24 that control the inlet valves 5 and the exhaust valves 6. It also shows that the crankshaft gears 23 driving the power output axle 20.

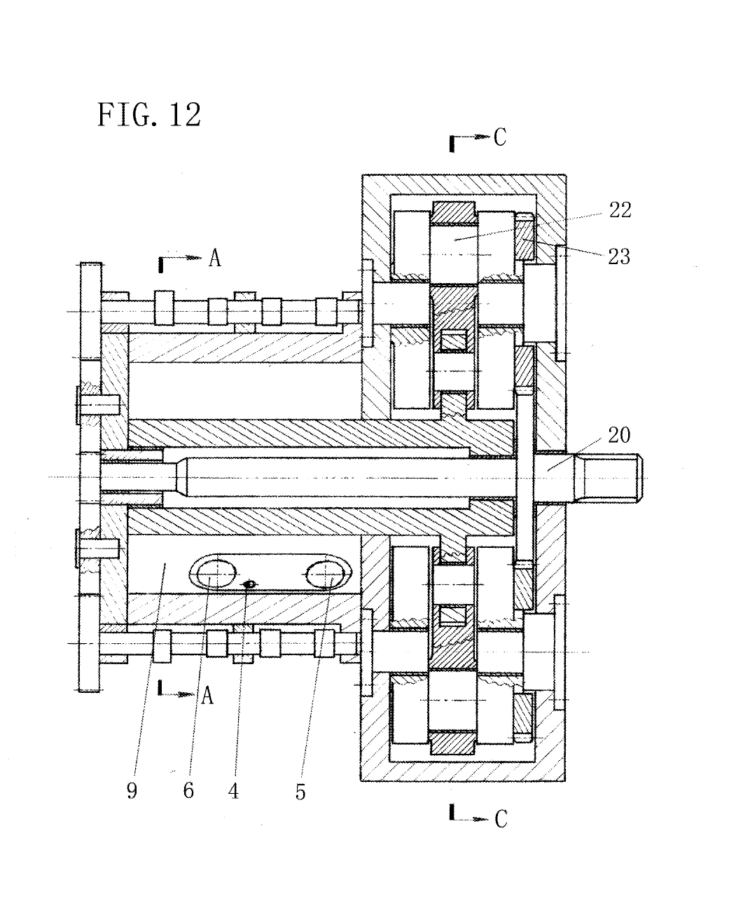

FIG. 12 is cross-sectional view showing both the combustion chambers 9 and the crankshaft 22.

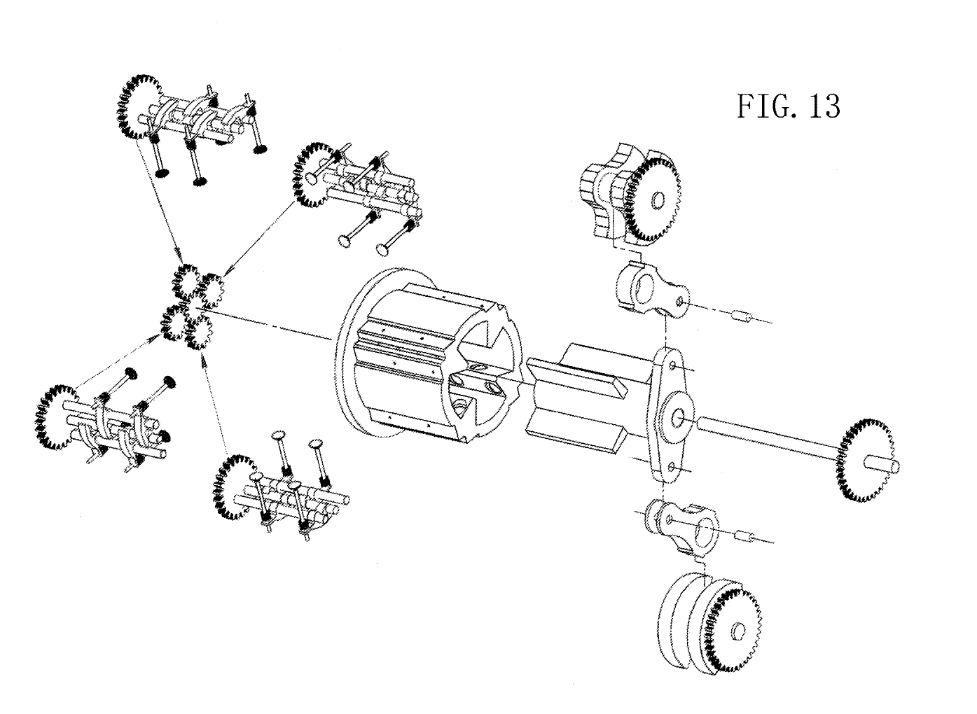

FIG. 13 is an exploded perspective view of the preferred embodiment.

What is claimed is:

1. A rotary internal combustion engine comprising
an outer stator shell that forms one or more than one equally-sized stator chambers,
an oscillating axle comprising pistons extending into each of the stator chamber, separating each stator chamber into two combustion chambers,
a combustion enabling means to enable each combustion chamber to combust, and
a translation means that translates the oscillation of the oscillating axle into a mono-directional rotary motion of a power output axle.

2. The rotary internal combustion engine of claim 1 where the combustion enabling means comprises spark plugs, inlet valves, and exhaust valves;

3. The rotary internal combustion engine of claim 2 where the spark plugs, the inlet valves, and the exhaust valves, are installed on the stator chambers;

4. The rotary internal combustion engine of claim 3 where the spark plugs, the inlet valves, and the exhaust valves, are installed on both sides of the stator chamber, enabling both combustion chambers for each of the stator chamber;

5. The rotary internal combustion engine of claim 1 where the combustion enabling means comprises a control means that opens and closes the inlet valves and the exhaust valves, and fires the spark plugs;

6. The rotary internal combustion engine of claim 5 where the control means comprises gears that use the rotation of the power output axle to control the operation of the inlet valves and the exhaust valves.

7. The rotary internal combustion engine of claim 1 where the translation means comprises two arms extending from the oscillating axle and driving two crankshafts that translate the oscillation of the oscillating axle to mono-directional rotation of two off-center crankshaft gears, which drive the power output axle.

8. The rotary internal combustion engine of claim 1 where the outer stator shell forms four equal-sized stator chambers;

9. The rotary internal combustion engine of claim 1 where the outer stator shell forms two equal-sized stator chambers;

10. The rotary internal combustion engine of claim 1 where the outer stator shell forms six equal-sized stator chambers;
